(19) United States
(12) Patent Application Publication
(10) Pub. No.: US 2025/0211562 A1
(43) Pub. Date: Jun. 26, 2025

(54) DEVICE FOR MANAGING PLURALITY OF IOT DEVICES, AND OPERATION METHOD THEREOF

(71) Applicant: SAMSUNG ELECTRONICS CO., LTD., Suwon-si (KR)

(72) Inventors: Donghyuk KIM, Suwon-si (KR); Hodong LEE, Suwon-si (KR); Rajasimhan BASKAR, Suwon-si (KR)

(73) Assignee: SAMSUNG ELECTRONICS CO., LTD., Suwon-si (KR)

(21) Appl. No.: 19/078,064

(22) Filed: Mar. 12, 2025

Related U.S. Application Data
(63) Continuation of application No. PCT/KR2023/011989, filed on Aug. 11, 2023.

(30) Foreign Application Priority Data
Sep. 20, 2022 (KR) 10-2022-0118495

(51) Int. Cl. H04L 61/00; G16Y 40/35

(52) U.S. Cl. CPC H04L 61/35; G16Y 40/35

(57) ABSTRACT

An operation method of a server device includes receiving an Internet protocol (IP) address of an Internet-of-Things (IoT) device from the IoT device, identifying another IoT device having a same IP address as the IP address of the IoT device, based on there being no link generated between the IoT device and the another IoT device, generating a link between the IoT device and the another IoT device, based on there being a link generated between the IoT device and the another IoT device, increasing a weight for the link generated between the IoT device and the another IoT device, and generating data on the IoT device and the another IoT device based on the weight for the generated link.

### CROSS-REFERENCE TO RELATED APPLICATIONS

This application is a bypass continuation application of International Application No. PCT/KR2023/011989, filed on Aug. 11, 2023, which claims priority to Korean Patent Application No. 10-2022-0118495, filed on Sep. 20, 2022, in the Korean Intellectual Property Office, the disclosures of which are incorporated by reference herein in their entireties.

### BACKGROUND

### 1. Field

The disclosure relates to a device for managing a plurality of Internet-of-Things (IoT) devices and an operation method thereof, and more particularly, to a device for managing a plurality of IoT devices for each household and an operation method thereof.

### 2. Description of Related Art

With the development of IoT technology, IoT devices equipped with IoT functions (e.g., TVs, refrigerators, vacuum cleaners, washing machines, smartphones, laptops, etc.) are becoming more popular in ordinary households. In order to conduct research and development of IoT devices in consideration of consumer needs and to perform effective marketing and advertisements for consumers, it is important to obtain data such as the type and number of those IoT devices owned by each household, a change in penetration rate thereof and the like.

In this context, it may be possible to identify IoT devices in a household based on a user's account that connects to the IoT devices, but even in such a case, some IoT devices may not be identified as being in the same household even though they are actually present, in case that they are not logged-in with the user's account, or they are logged-in with another user's account.

### SUMMARY

With regard to IoT devices disposed within the same household, where those IoT devices are not logged-in with a predetermined account, are logged-in with different accounts or public accounts, or are logged-in with a single IoT device through multiple accounts, data related to the current status of the IoT devices for each household may not be accurately and consistently collected and analyzed, so that reliability of data collection and analysis may deteriorate.

Embodiments of the disclosure provide an apparatus for generating data on IoT devices installed for each household based on an IP address and an operation method thereof.

Embodiments of the disclosure provides a device for accurately determining the type and number of IoT devices owned by each household, the status of product replacement, and so on, and a method for operating the same.

According to an aspect of the disclosure, there is provided an operation method of a server device including: receiving an Internet protocol (IP) address of an Internet-of-Things (IoT) device from the IoT device; identifying another IoT device having an IP address that is the same as the IP address of the IoT device; based on there being no link generated between the IoT device and the another IoT device, generating a link between the IoT device and the another IoT device; based on there being a link generated between the IoT device and the another IoT device, increasing a weight for the link generated between the IoT device and the another IoT device; and generating data on the IoT device and the another IoT device based on the weight for the generated link.

The operation method may include identifying one or more links having a weight equal to or greater than a threshold among a plurality of links generated between a plurality of IoT devices including the IoT device and the another IoT device.

The operation method may include identifying at least one link that is connected among the one or more links; and identifying two or more IoT devices connected through the at least one link.

The operation method may include: generating a group including the two or more IoT devices; and generating an identifier for the group.

The operation method may include generating the two or more IoT devices as the group, based on a preset time having elapsed in the server device.

The operation method may include: identifying an anchor IoT device having a same IP address while the preset time elapses; and generating a group including the anchor IoT device.

The operation method may include receiving device information of the IoT device from the IoT device, wherein the device information of the IoT devices includes information on an access point (AP) to which the IoT device is connected, identification information of the IoT device, and information on an external device connected to the IoT device.

The operation method may include adding an external device connected to the two or more IoT devices to the group, based on the information on the external device.

The device information may include the IP address.

The operation method may include identifying that the IP address of the IoT device changes based on the device information.

According to an aspect of the disclosure, there is provided a server device including: a communication interface; memory storing at least one instruction; and at least one processor operatively connected to the communication interface and the memory, and configured to execute the at least one instruction, wherein the at least one instruction, when executed by the at least one processor, cause the server device to: receive an Internet protocol (IP) address of an Internet-of-Things (IoT) device from the IoT device; identify another IoT device having the same IP address as the IP address of the IoT device; based on there being no link generated between the IoT device and the another IoT device, generate a link between the IoT device and the another IoT device; based on there being a link generated between the IoT device and the another IoT device, increase a weight for the link generated between the IoT device and the another IoT device; and generate data on the IoT device and the another IoT device, based on the weight for the generated link.

The at least one instruction, when executed by the at least one processor, may cause the server device to identify one or more links having a weight equal to or greater than a threshold among a plurality of links generated between a plurality of IoT devices including the IoT device and the another IoT device.

The at least one instruction, when executed by the at least one processor, may cause the server device to identify at least one link that is connected among the one or more links, and identifies two or more IoT devices that are connected via the at least one link.

The at least one instruction, when executed by the at least one processor, may cause the server device to generate a group including the two or more IoT devices, and generates an identifier for the group.

The at least one instruction, when executed by the at least one processor, may cause the server device to, based on a preset time having elapsed in the server device, generate the two or more IoT devices as the group.

According to examples disclosed herein, the disclosure provides an advantageous effect capable of accurately identifying IoT device data based on a user's account or identification information of an IoT device, as well as data related to IoT devices for each household.

Further, according to examples disclosed herein, the disclosure provides an advantageous effect capable of accurately identifying the type and number of IoT devices installed within each household, and performing marketing for each household on the basis of the data, resulting in more efficient advertising effect.

Effects that can be obtained from the present disclosure are not limited to those mentioned above, and other effects not mentioned herein may be clearly understood by those having ordinary knowledge in the technical field to which the disclosure belongs from the following description.

### BRIEF DESCRIPTION OF THE DRAWINGS

The above and other aspects and/or features of one or more embodiments of the disclosure will be more apparent from the following detailed description, taken in conjunction with the accompanying drawings, in which:

FIG. 1 illustrates an example of an IoT environment according to an embodiment;

FIG. 2 illustrates a block configuration of a server device according to an embodiment;

FIG. 3 illustrates a block configuration of an IoT device according to an embodiment;

FIG. 4 illustrates an example of a process, performed by a server device, of grouping IoT devices existing for each household, according to an embodiment; and

FIG. 5 illustrates an operation flow of a server device according to an embodiment.

### DETAILED DESCRIPTION

One or more embodiments are described with reference to the accompanying drawings. However, they are not intended to limit the disclosure to any particular embodiment and are to be understood to include various modifications, equivalents, and/or alternatives of the embodiments. In the following description, the same or similar reference numerals are used for substantially the same or similar components, and redundant descriptions may be omitted.

With regard to the description of drawings, the same or similar reference numerals may be used to refer to the same or similar components.

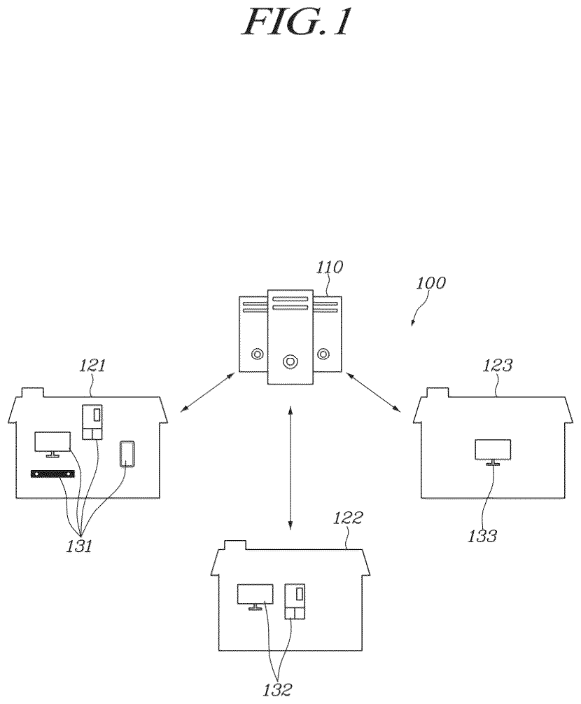

FIG. 1 illustrates an example of an IoT environment according to an embodiment.

Referring to FIG. 1, an IoT environment 100 according to an embodiment may include a server device 110, an IoT device 131 included in a first household 121, an IoT device 132 included in a second household 122, and an IoT device 133 included in a third household 123.

The server device 110 according to an embodiment may indicate an IoT network server for managing IoT devices. The server device 110 may perform data communication with a plurality of IoT devices. The server device 110 may perform bidirectional communication with a plurality of IoT devices in a wired and wireless communication scheme.

The server device 110 according to an embodiment may perform communication with the IoT devices 131, 132, and 133. Although not illustrated herein, an access point (AP) for communicating between the server device 110 and the IoT devices may be installed in the first household 121, the second household 122, and the third household 123. The IoT devices 131, 132, and 133 may perform communication with the server device 110 via the AP installed in each household.

The server device 110 according to an embodiment may manage data about IoT devices positioned in each household. For example, the server device 110 may receive, from the IoT devices, overall data about the IoT devices, such as e.g., the number of IoT devices possessed by each household (e.g., three inclusive of a TV, a refrigerator, and a monitor), the type of IoT devices (e.g., TV, refrigerator, monitor, sound bar, washing machine, etc.), device information of IoT devices (e.g., manufacturer, manufacturing date, software information, identification information, etc.), connection information of IoT devices (e.g., information on an external device such as a sound bar connectable to a TV), account information of the IoT device (e.g., information about a login account) of the IoT device, and so on, or may transmit specific data to the IoT devices.

In an embodiment, the types and the number of IoT devices possessed by each household may be different from each other. For example, referring to FIG. 1, the IoT device 131 of the first household 121 may include four different types of IoT devices such as a TV, a sound bar, a refrigerator, and a mobile phone, the IoT device 132 of the second household 122 may include two types of IoT devices such as a TV and a refrigerator, and the IoT device 133 of the third household 123 may include only one TV device. An example of the IoT device for each household illustrated in FIG. 1 is merely of an example, and the server device 110 may manage data about the IoT devices for a larger number of households than three. Further, for example, two or more IoT devices of the same type may be arranged in one household.

Although not illustrated in the drawing, when the IoT devices 131, 132, and 133 are connected to an AP, the IoT devices 131, 132, and 133 may be respectively assigned an IP address through the AP. The IP addresses that may be assigned to the IoT devices 131, 132, and 133 may be set and updated in the AP by a network administrator. Further, the IoT devices 131, 132, and 133 may communicate with an exterior network via the AP. In this case, the IoT device connected via the same AP has the same IP address (e.g., the same authorized IP address) with respect to the network.

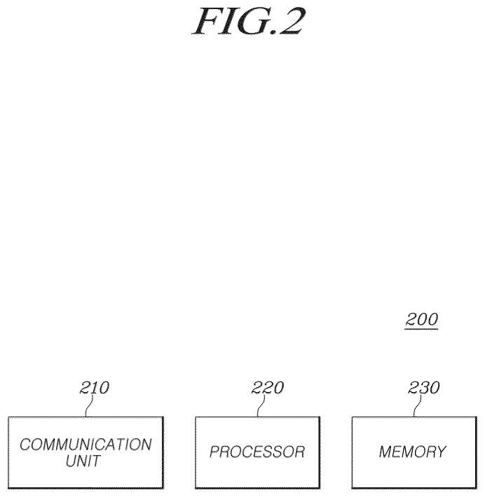

FIG. 2 illustrates a block configuration of a server device according to an embodiment.

Referring to FIG. 2, a server device 200 according to an embodiment may include a communication unit 210, a processor 220, and a memory 230. The server device 200 may indicate a device corresponding to the server device 110 of FIG. 1.

According to an embodiment, the communication unit 210 performs a function for transmitting and receiving signals through a wired or wireless channel. For example, the communication unit 210 performs a function of data conversion in between a baseband signal and a bit stream according to a certain physical layer specification of a system. The communication unit 210 may be referred to as a transmitter, a receiver, and a transceiver.

In an embodiment, the communication unit 210 may receive data of an IoT device from the IoT device (e.g., the IoT devices 131, 132, and 133). In an embodiment, the communication unit 210 may communicate with an IoT device through an AP.

According to an embodiment, the memory 230 may store data such as a basic program, an application program, and setting information for an overall operation of the server device 200.

In an embodiment, the memory 230 may store data received from the IoT device (e.g., the IoT devices 131, 132, and 133). For example, the memory 230 may store an IP address of the IoT device. For example, the memory 230 may store device information of the IoT device (e.g., identification information, device type, manufacturing date and time of the device, manufacturer of the device, information on connection history of the device, etc.).

In an embodiment, the memory 230 may provide stored data according to a request from the processor 220.

According to an embodiment, the processor 220 may execute an operation or data processing related to control and/or communication of at least one other component of the server device 200, by executing at least one instruction stored in the memory 230. The processor 220 may include at least one of a central processing unit (CPU), a graphics processing unit (GPU), a micro controller unit (MCU), a sensor hub, a supplementary processor, a communication processor, an application processor, an application specific integrated circuit (ASIC), or a field programmable gate array (FPGA), and may have a plurality of cores.

In an embodiment, the processor 220 may receive device information (e.g., an IP address) of IoT devices from the IoT devices installed within each household for a predetermined period (e.g., one day, one week, or one month). The predetermined period may vary depending on the setting of the server device.

In an embodiment, the processor 220 may receive device information of the IoT device on a periodic or aperiodic basis for a predetermined period, and may store the device information in the memory 230.

In an embodiment, the server device 200 may receive the device information about each of the plurality of IoT devices present in the plurality of households, and may store the device information in the memory 230 and generate data about the IoT devices for each household based thereon.

In an embodiment, the processor 220 may receive data including the IP address of the IoT device from the IoT device according to a request of the server device 200 or another device, and even if there is not such a request, when performing an operation different from the IoT devices (e.g., when a network server receives data related to content requested by the IoT device or receives Keep alive data transmitted by the IoT device periodically), the processor 220 may receive the IP address of the IoT device through data received through the different operation.

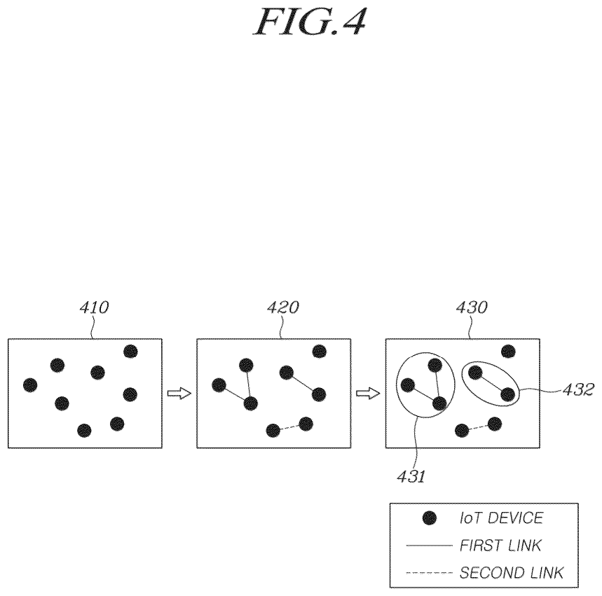

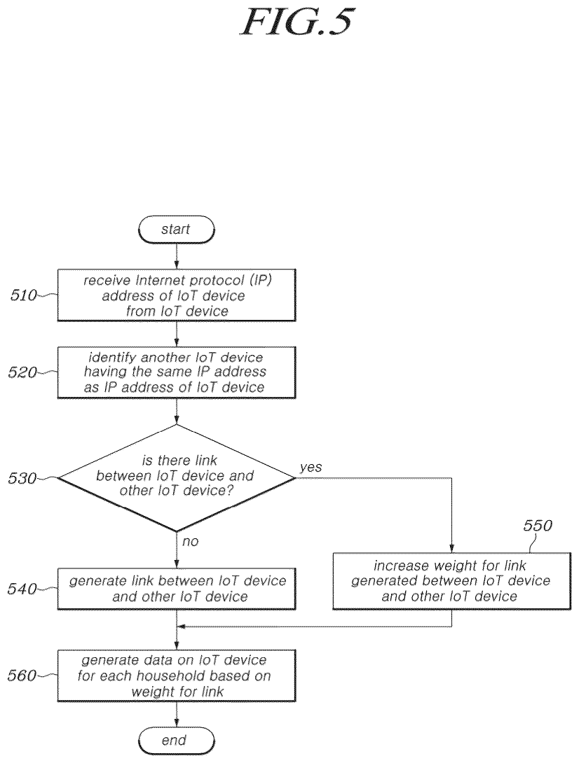

The operation of the server device according to embodiments of the disclosure is not a one-time operation, but rather relates to techniques for receiving data, including IP addresses, on a periodic or aperiodic basis from IoT devices several times for a certain period of time to identify IoT devices that are estimated to be installed within the same household and to establish weights for these IoT devices, thereby accurately determining which IoT devices are disposed within the same household, based on the data related to the weights accumulated over the period of time. Detailed operations of the server device will be described in detail with reference to FIGS. 4 and 5 to be described later.

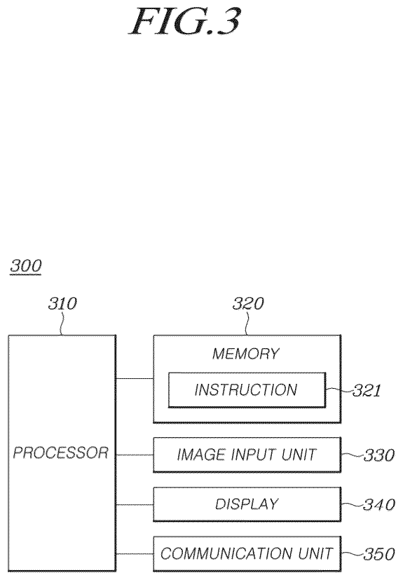

FIG. 3 illustrates a block configuration of an IoT device according to an embodiment. An IoT device 300 of FIG. 3 may indicate a device including the IoT devices 131, 132, and 133 of FIG. 1. In addition, the IoT device 300 may refer to a wearable terminal such as a smart watch and glasses capable of performing various computing functions such as e.g., real-time video watching, chatting, and communication. The IoT device 300 may refer to various types of terminals but not limited to the above-described contents.

According to an embodiment, the memory 320 is a storage medium used by the IoT device 300, and may store data such as e.g., at least one instruction 321 corresponding to at least one program or setting information for that device. The program may include an operating system (OS) program and various application programs.

In an embodiment, the memory 320 may store pairing information of an external electronic device located adjacent to the IoT device 300. In an embodiment, the pairing information may include device information of the external electronic device, information about another external electronic device or a remote control device paired with the external electronic device, information about a scheme (e.g., Bluetooth or Wi-Fi) in which the external electronic device is paired with the other external electronic device or the remote control device, information about a pairing history between the external electronic device and the other external electronic device or the remote control device, or the like.

In an embodiment, the memory 320 may include at least one type of storage medium of a flash memory type memory, a hard disk type memory, a multimedia card micro type memory, a card type memory (e.g., secure digital (SD) or extreme digital (XD) memory), a random access memory (RAM), a static random access memory (SRAM), a read only memory (ROM), an electrically erasable programmable (EEPROM), a programmable ROM (PROM), a magnetic memory, a magnetic disk, an optical disk and so on.

According to an embodiment, an image input unit 330 may receive a real-time viewing image and real-time viewing image information through a tuner, an input/output unit, or a communication unit 350. The image input unit 330 may include at least one of the tuner and the input/output unit. The tuner may tune and select only a frequency of a broadcast channel to be received by the IoT device 300 from among a number of radio wave components through amplification, mixing, resonance, or the like of a broadcast signal received by a wired or wireless mode. The broadcast signal may include video, audio, and additional data (e.g., an electronic program guide (EPG)). The tuner may receive a real-time broadcasting channel (or a real-time viewing image) from various broadcasting sources such as terrestrial broadcasting, cable broadcasting, satellite broadcasting, Internet broadcasting, and the like. The tuner may be implemented integrally with the IoT device 300 or may be implemented as a separate tuner electrically connected to the IoT device 300. The input/output unit may include at least one of a High Definition Multimedia Interface (HDMI) input port, a component input jack, a PC input port, or a USB input jack capable of receiving a real-time viewing image and real-time viewing image information from an external device of the IoT device 300 under the control of the processor 310. It will be obvious to an expert skilled in the art that the input/output unit may be added, deleted, and/or changed depending on the performance and structure of the IoT device 300.

According to an embodiment, a display 340 may perform functions for outputting information in the form of numbers, characters, images, and/or graphics. The display 340 may include at least one hardware module for outputting the information. The at least one hardware module may include, for example, at least one of a liquid crystal display (LCD), a light emitting diode (LED), a light emitting polymer display (LPD), an organic light emitting diode (OLED), an active matrix organic light emitting diode (AMOLED), or a flexible LED (FLED). The display 340 may display a screen corresponding to data received from the processor 310. The display 340 may be referred to as ‘output unit’, ‘display unit’, or other terms having a technical meaning equivalent thereto.

According to an embodiment, the communication unit 350 may provide a wired/wireless communication interface that enables communication with an external device. The communication unit 350 may include at least one of a wired Ethernet communication unit, a wireless LAN communication unit, and a short-range communication unit. The wireless LAN communication unit may include, for example, Wi-Fi and may support the wireless LAN standard IEEE802.11x of the American Institute of Electrical and Electronics Engineers (IEEE). The wireless LAN communication unit may be wirelessly connected to an access point (AP) under the control of the processor 310. The short-range communication unit may wirelessly perform short-range communication with an external device under the control of the processor 310. The short-range communication may include Bluetooth, Bluetooth Low Energy, Infrared Data Association (IrDA), Ultra-Wide Band (UWB), Near Field Communication (NFC), and the like. The external device may include a server device providing an image or chat service and a mobile terminal (e.g., a mobile phone, a tablet, etc.).

According to an embodiment, the processor 310 may execute an operation or data processing related to control and/or communication of at least one other component of the IoT device 300, by executing at least one instruction 321 stored in the memory 320. The processor 310 may include at least one of a central processing unit (CPU), a graphics processing unit (GPU), a micro controller unit (MCU), a sensor hub, a supplementary processor, a communication processor, an application processor, an application specific integrated circuit (ASIC), or a field programmable gate array (FPGA), and may have a plurality of cores.

FIG. 4 illustrates an example of a process, performed by a server device, of grouping IoT devices existing for each household, according to an embodiment. The IoT device of FIG. 4 may be a device corresponding to the IoT devices 131, 132, and 133 of FIG. 1 and the IoT device 300 of FIG. 3. The server device of FIG. 4 may be a device corresponding to the server device 110 of FIG. 1 and the server device 200 of FIG. 2.

In an embodiment, the server device 200 may identify a plurality of IoT devices for a predetermined period of time. Referring to FIG. 4, a plurality of IoT devices identified by the server device 200 are illustrated as separate nodes, respectively. The plurality of IoT devices identified by the server device 200 may represent IoT devices managed by the server device 200. Information on the plurality of IoT devices identified by the server device 200 (e.g., IP address, type and product number of device, manufacturing date of device, manufacturer of device, etc.) may be stored in the memory 230 of the server device 200. The plurality of IoT devices may refer to a plurality of IoT devices present in a plurality of households.

In an embodiment, the server device 200 may identify a plurality of IoT devices based on the IP address of the IoT device included in the data transmitted by the IoT device. For example, the IoT device may transmit data related to the state of the IoT device and data related to the operation to the server device 200 in a variety of occasions, such as e.g., when the power is turned on or turned off, when a user transmits an operation signal to the IoT device (e.g., a TV) via a remote control device (e.g., a remote control), when the IoT device is a smartphone, when a specific object (e.g., a physical button, a specific icon of a user interface (UI), or the like) of the smartphone is selected, and so on. The data transmitted by the IoT device may include the IP address of the AP to which the IoT device is connected. In addition, for example, the server device 200 may identify a plurality of different IoT devices based on the IP address of the IoT device and device information of the IoT device (e.g., device type, device manufacturing date, software information, etc.).

In an embodiment, the predetermined period of time may refer to a total period of time for which the server device 200 generates data about the IoT device for each household, and the predetermined period of time may include a plurality of sub-periods. Since the IP address allocated to the household may change over time, the predetermined period of time may be determined dividing the predetermined period of time into a plurality of sub-periods. The server device 200 may set a plurality of sub-periods distinguished for each type of IoT device.

Referring to FIG. 4, in an embodiment, the server device 200 may identify a plurality of IoT devices in a first stage 410.

According to an embodiment, in a second stage 420, the server device 200 may receive data including an IP address from a plurality of IoT devices for a predetermined period of time, and in case where two or more IoT devices having the same IP address are identified, may establish a link between the two or more IoT devices having the same IP address. When the server device 200 identifies two or more IoT devices having the same IP address, the server device 200 may determine that the two or more IoT devices are connected to the same AP.

In an embodiment, the server device 200 may assign a weight to each link between IoT devices, respectively. The server device 200 may determine the weight for the link based on the Jaccard Similarity, which may be specifically determined based on the following equation.

Wₑ=Jaccard(N₁, N₂) Equation 1
wherein, ‘W’ indicates a weight, and ‘e’ indicates a link (edge) to which a weight is assigned. Further, ‘N₁’ may refer to one IoT device connected to a specific link, and ‘N₂’ may refer to another IoT device connected to the specific link.

In an embodiment, when there exists a link already generated between two or more IoT devices having the same IP address, the server device 200 may increase the weight to the link.

In an embodiment, the server device 200 may identify the IoT device (hereinafter, referred to as a unique node) having the same IP address without any change for a predetermined period. When the server device 200 identifies a unique node, the server device 200 may generate IoT device data for each household based on the unique node. In other words, the server device may determine an IoT device that has the same IP address as the unique node or has ever had the same, as being the IoT device existing in the same household.

In an embodiment, the server device 200 may identify the unique node using the aforementioned Jaccard Similarity. For example, based on the number of times that any link is not established in a specific IoT device and is identified alone, the Jaccard Similarity may be checked, and where a predetermined threshold or more is obtained, the corresponding IoT device may be determined as a unique node.

In an embodiment, the server device 200 may determine one or more IoT devices connected through a first link having a weight greater than or equal to a threshold, as one group. The first link may refer to a link having a weight greater than or equal to a threshold, and the second link may refer to a link in which a link has been generated between nodes but the weight does not exceed the threshold, which link may mean a link temporarily established due to a coincidental match of IP addresses for a predetermined period. For example, in a third stage 430, the server device 200 may determine, as a first group 431, three IoT devices that are connected without being separated through the first link having a weight greater than or equal to the threshold. In addition, the server device 200 may determine, as a second group 432, two IoT devices that are connected without being separated through the first link having the weight greater than or equal to the threshold. For the second link, the weight does not exceed the threshold, and therefore, even if the link has been established, it may not be determined as one group.

FIG. 5 illustrates an operation flow of a server device according to an embodiment. The operation of the server device described with reference to FIG. 5 may include all or some of the operations of the server device 200 described with reference to FIG. 4. The operation of FIG. 5 relates to an operation performed by the server device at each time point, in order to group data about IoT devices existing for each household according to FIG. 4, that is, the IoT devices determined to exist in the same household.

According to an embodiment, in operation 510, the server device may receive from an IoT device an Internet protocol (IP) address of the IoT device.

In an embodiment, the server device may receive data periodically or aperiodically transmitted by the IoT device, and may identify the IP address of the IoT device included in the data.

According to an embodiment, in operation 520, the server device may identify another IoT device having the same IP address as the IP address of the IoT device.

In an embodiment, after identifying the IP address of the IoT device, the server device may identify whether there is another IoT device having the same IP address as the IP address of the IoT device, based on the information on a plurality of IoT devices stored in the memory of the server device.

According to an embodiment, in operation 530, the server device may determine whether there is a link generated between the IoT device and the other IoT device.

In an embodiment, the server device may determine whether there is a link generated between the IoT device and the other IoT device, based on data about the plurality of IoT devices included in the information about the plurality of IoT devices stored in the memory.

According to an embodiment, in operation 540, when there is no link generated between the IoT device and the other IoT device, the server device may generate a link between the IoT device and the other IoT device. The link may also be referred to as an edge.

According to an embodiment, in operation 550, when there is a link generated between the IoT device and the other IoT device, the server device may increase a weight for the link generated between the IoT device and the other IoT device.

According to an embodiment, in operation 560, the server device may generate data on the IoT device for each household based on the weight for the link.

In an embodiment, the weight is a value indicating a probability that IoT devices exist in the same household, and may refer to a value increased when it is identified that two or more IoT devices have the same IP address. Even though any IoT device does not actually exist in the same household, it may happen to accidentally have the same IP address as that present in the household, in the process of the network allocating the IP address to each household, and in this case, it may be difficult to generate accurate data on IoT devices for each household as those IoT devices are deemed to exist in the same household. As such, rather than determining whether there are different IoT devices having the same IP address at a time, the server device may monitor as to whether there are IoT devices having the same IP address several times for a predetermined period of time, and generate data on IoT devices for each household based on the weight determined in the monitoring operation, thereby identifying the current status of IoT devices for each household with high accuracy.

In an embodiment, the server device may identify one or more links having a weight equal to or greater than the threshold among a plurality of links generated between a plurality of IoT devices including the IoT device and the other IoT device. The one or more links having the weight equal to or greater than the threshold among the plurality of links are links to the IoT devices identified a predetermined number of times or more as having the same IP address, and may refer to links of the IoT devices estimated to be disposed in the same household.

In an embodiment, the server device may identify at least one link that is connected without being separated among the one or more links. The server device may identify two or more IoT devices connected through the at least one link. The server device may generate a group including the two or more IoT devices. In case where the links having a value equal to or greater than the threshold are separated from each other without connection, the server device may determine that link as being a separate household.

In an embodiment, the server device may determine one or more links that are connected without being separated as IoT devices belonging to one household. A group may refer to one household, and for example, each of the first group 431 and the second group 432 represents IoT devices for each household.

In an embodiment, the server device may determine the first group 431 and the second group 432, which are connected without being separated to each other among the links (the first links) having a weight equal to or greater than the threshold, as a respective household.

In an embodiment, the server device may generate an identifier for the group. For example, this is to continuously generate data on IoT devices for each household even if the IP address is changed later, by separately generating the identifier for the first group 431 and the identifier for the second group 432.

Based on the data on the IoT devices for each household generated according to the foregoing description, the server device may determine device replacement for each household over time.

In an embodiment, the server device may generate data about the IoT devices for each household in a predetermined period of time in the same manner as described with reference to FIGS. 4 and 5. As such, based on the data on the IoT device for each household generated for every predetermined period, the server device may generate a graphic representation (hereinafter, referred to as a ‘household device graph’) on a changing trend of the IoT devices for each household.

In an embodiment, the server device may identify a change in the IoT devices for each household based on the household device graph generated based on the data about the IoT device for each household. For example, in the event that the server device generates data about the IoT devices for each household on a monthly basis, the server device may compare the generated data with data about the IoT device for each household generated a month ago and then identify which IoT devices have been added, deleted, or moved to which household.

In an embodiment, the server device may manage the life cycle of IoT devices. For example, the server device may determine that an IoT device has completely disappeared (or dead). Further, for example, the server device may determine that an IoT device is temporarily in an inactive state.

In an embodiment, when it is identified that the IoT device was last observed before a predetermined time period a from the time point at which the IoT device is observed, the server device may determine that the IoT device has completely disappeared (or dead). In an embodiment, when the IoT device was last observed before a time period b from the time point of the observation and is observed at a time period shorter than the time period a, the server device may determine that the IoT device has been temporarily deactivated. For example, the time period a may be 30 days and the time period b may be 100 days.

In an embodiment, the server device may identify a change in the IoT devices for each household by comparing data about the IoT device for each household generated first (hereinafter, referred to as first household data) with data about the IoT device for each household generated next (hereinafter, referred to as second household data). For example, the server device may compare the first household data with the second household data to determine that there is no change in the IoT device retained in the household.

In an embodiment, the server device may compare the first household data with the second household data to determine that the IoT devices retained in the household partially overlap. For example, the server device may compare the first household data with the second household data to determine that a new device was added. When a new IoT device was added compared to IoT devices existing in households in the past, and when the IoT device is one observed for the first time, it may be that the new IoT device has been purchased, while when it is identified as an IoT device existing in another household before, it may be determined as a transaction (purchase) between households. For example, the server device may compare the first household data with the second household data to determine that some IoT devices are lost (devices lost). When the number of IoT devices included in the second household data is less than the number of IoT devices included in the first household data, the server device may determine that the IoT device is separated from the corresponding household. When the corresponding IoT device is found in another household, the server device may determine that the corresponding IoT device has been traded (sold). For example, the server device may compare the first household data with the second household data to determine that a new household has been generated based on one or more newly observed IoT devices. For example, the server device may compare the first household data with the second household data to determine that all IoT devices for each household have disappeared.

As such, when the life cycle has been set to the past inactive state and is included in the data about the IoT devices of the new household, the server device may change the state of that IoT device back to the active state.

Based on the data about IoT devices for each household generated based on the foregoing description, the server device may minimize data errors in those IoT devices existing for each household, perform efficient marketing based on the brand royalties and the device status for each household, and also provide an effect capable of determining purchasing power of consumers.

The electronic device according to various embodiments disclosed herein may be one of various types of electronic devices. The electronic devices may include, for example, a display device, a portable communication device (e.g., a smartphone), a computer device, a portable multimedia device, a portable medical device, a camera, a wearable device, or a home appliance. The electronic devices according to an embodiment of the disclosure are not limited to those described above.

It should be appreciated that various embodiments of the present disclosure and the terms used therein are not intended to limit the technological features set forth herein to particular embodiments and include various changes, equivalents, or replacements for a corresponding embodiment. For example, a component expressed in the singular is to be understood as including a plurality of components unless the context clearly indicates only a singular meaning. As used in the disclosure, the term “and/or” is to be understood to encompass all possible combinations of one or more of the enumerated items. As used in the disclosure, the terms “comprise”, “have”, “include”, “consist of”, and the like are intended only to designate the presence of features, components, parts, or combinations thereof described in the disclosure, and the use of such terms is not intended to exclude the possibility of presence or addition of one or more other features, components, parts, or combinations thereof. As used herein, each of such phrases as “A or B”, “at least one of A and B”, “at least one of A or B”, “A, B, or C”, “at least one of A, B, and C”, and “at least one of A, B, or C” may include any one of, or all possible combinations of the items enumerated together in a corresponding one of the phrases. As used herein, such terms as “1st”, “2nd”, or “first” or “second” may be used to simply distinguish a corresponding component from another, and does not limit the components in other aspect (e.g., importance or order).

As used in connection with various embodiments of the disclosure, the term “˜ unit” or “˜ module” may include a unit implemented in hardware, software, or firmware, and may be interchangeably used with other terms, for example, “logic”, “logic block”, “part”, or “circuit”. Such a “˜ portion” or “˜ module” may be a single integral component, or a minimum unit or a part of the component, adapted to perform one or more functions. For example, according to an embodiment, the “˜ portion” or “˜ module” may be implemented in the form of an application-specific integrated circuit (ASIC).

As used in connection with various embodiments of the disclosure, the term “in case where (or that) ˜” may be interpreted to mean “when ˜”, “if ˜”, “in response to determining ˜”, or “in response to detecting ˜”, depending on the context. Similarly, the phrases “when it is determined that ˜” or “when it is detected that ˜” may be interpreted to mean “when determining ˜”, “in response to determining ˜”, “when detecting ˜” or “in response to detecting ˜”, depending on the context.

The program executed by a server device 200 as described in the disclosure may be implemented as a hardware component, a software component, and/or a combination of the hardware component and the software component. The program may be performed by any system capable of executing computer-readable instructions.

Software may include a computer program, a code, an instruction, or a combination of one or more of them, and may configure a processing unit to operate as desired or instruct the processing unit independently or collectively. The software may be implemented as a computer program including instructions stored in a computer-readable storage medium. The computer-readable storage media may include, for example, magnetic storage media (e.g., read-only memory (ROM), random-access memory (RAM), a floppy disk, hard disk, etc.), optical readable media (e.g., compact disc read only memory (CD-ROM), digital versatile disc (DVD)) and the like. The computer-readable storage media may be distributed over networked computer systems, so that computer-readable codes may be stored and executed in a distributed manner. The computer program product may be distributed (e.g., downloaded or uploaded) directly or online through an application store (e.g., PlayStore™) or between two user devices (e.g., smartphones). If distributed online, at least part of the computer program product may be at least temporarily stored or generated in a machine-readable storage medium, such as memories of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more components or operations of the above-described components may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An operation method of a server device, the operation method comprising:
receiving an Internet protocol (IP) address of an Internet-of-Things (IoT) device from the IoT device;
identifying another IoT device having an IP address that is the same as the IP address of the IoT device;
based on there being no link generated between the IoT device and the another IoT device, generating a link between the IoT device and the another IoT device;
based on there being a link generated between the IoT device and the another IoT device, increasing a weight for the link generated between the IoT device and the another IoT device; and
generating data on the IoT device and the another IoT device based on the weight for the generated link.

2. The operation method of claim 1, further comprising identifying one or more links having a weight equal to or greater than a threshold among a plurality of links generated between a plurality of IoT devices including the IoT device and the another IoT device.

3. The operation method of claim 2, further comprising:
identifying at least one link that is connected among the one or more links; and
identifying two or more IoT devices connected through the at least one link.

4. The operation method of claim 3, further comprising:
generating a group including the two or more IoT devices; and
generating an identifier for the group.

5. The operation method of claim 4, further comprising generating the two or more IoT devices as the group, based on a preset time having elapsed in the server device.

6. The operation method of claim 5, further comprising:
identifying an anchor IoT device having a same IP address while the preset time elapses; and
generating the group including the anchor IoT device.

7. The operation method of claim 4, further comprising receiving device information of the IoT device from the IoT device,
wherein the device information of the IoT device includes information on an access point (AP) to which the IoT device is connected, identification information of the IoT device, and information on an external device connected to the IoT device.

8. The operation method of claim 7, further comprising adding an external device connected to the two or more IoT devices to the group, based on the information on the external device.

9. The operation method of claim 7, wherein the device information includes the IP address.

10. The operation method of claim 9, further comprising identifying that the IP address of the IoT device changes based on the device information.

11. A server device comprising:
a communication interface;
memory storing at least one instruction; and
at least one processor operatively connected to the communication interface and the memory, and configured to execute the at least one instruction,
wherein the at least one instruction, when executed by the at least one processor, causes the server device to:
receive an Internet protocol (IP) address of an Internet-of-Things (IoT) device from the IoT device;
identify another IoT device having an IP address that is the same as the IP address of the IoT device;
based on there being no link generated between the IoT device and the other IoT device, generate a link between the IoT device and the another IoT device;
based on there being a link generated between the IoT device and the another IoT device, increase a weight for the link generated between the IoT device and the another IoT device; and
generate data on the IoT device and the another IoT device, based on the weight for the generated link.

12. The server device of claim 11, wherein the at least one instruction, when executed by the at least one processor, causes the server device to identify one or more links having a weight equal to or greater than a threshold among a plurality of links generated between a plurality of IoT devices including the IoT device and the another IoT device.

13. The server device of claim 12, wherein the at least one instruction, when executed by the at least one processor, causes the server device to identify at least one link that is connected among the one or more links, and identifies two or more IoT devices that are connected via the at least one link.

14. The server device of claim 13, wherein the at least one instruction, when executed by the at least one processor, causes the server device to generate a group including the two or more IoT devices, and generate an identifier for the group.

15. The server device of claim 14, wherein the at least one instruction, when executed by the at least one processor, causes the server device to, based on a preset time having elapsed in the server device, generate the two or more IoT devices as the group.

16. The server device of claim 15, wherein the at least one instruction, when executed by the at least one processor, causes the server device to:
identify an anchor IoT device having a same IP address while the preset time elapses; and
generate the group including the anchor IoT device.

17. The server device of claim 14, wherein the at least one instruction, when executed by the at least one processor, causes the server device to receive device information of the IoT device from the IoT device,
wherein the device information of the IoT device includes information on an access point (AP) to which the IoT device is connected, identification information of the IoT device, and information on an external device connected to the IoT device.

18. The server device of claim 17, wherein the at least one instruction, when executed by the at least one processor, causes the server device to add an external device connected to the two or more IoT devices to the group, based on the information on the external device.

19. The server device of claim 17, wherein the device information includes the IP address.

20. The server device of claim 17, wherein the at least one instruction, when executed by the at least one processor, causes the server device to identify that the IP address of the IoT device changes based on the device information.
